(19) United States
(12) Patent Application Publication
(10) Pub. No.: US 2008/0147930 A1
(43) Pub. Date: Jun. 19, 2008

(54) MULTI-LAYER HARD DISK MOUNTING ARRANGEMENT OF AN ATCA CARD ASSEMBLY

(75) Inventor: Feng-Qing Su, Shan-Hua Town (TW)

Correspondence Address: ADLINK TECHNOLOGY INC., P.O. BOX 108-00403, TAIPEI, omitted

(73) Assignee: ADLINK TECHNOLOGY INC., Chungho City (TW)

(21) Appl. No.: 11/549,112

(22) Filed: Oct. 12, 2006

(51) Int. Cl. G06F 13/12

(52) U.S. Cl. 710/74

(57) ABSTRACT

An ATCA card assembly, which includes a rear transition module mounted on and electrically connected to a circuit board and having an electric connecting portion at one side, a holder frame mounted on the rear transition module to hold multiple hard disk drives in a stack, and an adapter, which has an adapter board affixed to the circuit board and front mounting lugs of the holder frame to secure the holder frame in place, and electrical connectors extending from the adapter board at different elevations and respectively connected to the electric connecting portion of the rear transition module and the hard disk drives.

### BACKGROUND OF THE INVENTION

1. Field of the Invention

The present invention relates to an ATCA (Advanced Telecom Computing Architecture) card and more particularly, to a multi-layer hard disk mounting arrangement of an ATCA card, which allows a number of hard disk drives to be mounted on the rear transition module above the circuit board in a stack, saving much the surface space of the circuit board for circuit layout.

2. Description of the Related Art

Currently, many enterprises install relatively cheaper mini servers to satisfy network traffic requirements. In order to improve further economic effect, blade servers are developed. A blade server is essentially a housing for a number of individual minimally-packaged computer motherboard “blades”, each including one or more processors, computer memory, computer storage, and computer network connections, but sharing the common power supply and air-cooling resources of the chassis. The idea is that by placing many blades in a single chassis, and then 19-inch rack-mounting them, systems can be more compact and powerful, but less expensive than traditional systems based on mainframes, or server farms of individual computers.

The machine case of a blade server can accommodate several tens of motherboard blades or more. One single motherboard blade is equivalent to a server. The motherboard blades of a server system use a common machine case, a commonly display, a common keyboard, a commonly power adapter, and other resources. Further, a blade server system has an intelligent system mounted inside the machine case to separate motherboard blade resources, specific works, or application programs running in the motherboard blades, allowing free use of the motherboard blades in the machine case of the blade server system. The most attractive advantage of a blade server is its high reliability and extendibility. Every blade server has the backup function. The hot plugging of the server machine case that supports blade servers and system component parts provides high applicability. When one individual blade server failed, another blade server can take the place without interrupting the service of the system. When wishing to increase the processing power of the system, it needs only to insert more blade servers and to arrange these resources at the place where the demand is most strong.

Further, an ATCA card for blade server has multiple blade slots for the mounting of multiple blade servers, and data storage means for storing data. According to conventional designs, an ATCA card allows installation of one single hard disk drive.

FIG. 5 is an exploded view of a conventional blade server chassis. According to this design, the blade server chassis A has an adapter card Al at one side, an electrical connector A11 at the adapter card A1, a positioning member A2, a retaining member A3 and a inside space A4. An interface module B is mounted in the inside space A4 of the blade server chassis A and secured in place by the retaining member A3. The interface module B has a positioning member B2 secured to the positioning member A2, and an electrical connector B1 electrically connected to the electrical connector A11. This interface module mounting arrangement has drawbacks as follows:
1. The interface module B occupies the full area of the inside space A4 of the blade server chassis A, interfering with the arrangement of circuits inside the blade server chassis A.
2. The electrical connector B1 and positioning member B2 of the interface module B are respectively fastened to the electrical connector A11 and the retaining member A3 of the blade server chassis A to secure the interface module B in place. This connection arrangement between the blade server chassis A and the interface module B is complicated.
3. The blade server chassis A can accommodate only one interface module B, i.e., the blade server chassis A has no extra space for expansion.

### SUMMARY OF THE INVENTION

The present invention has been accomplished under the circumstances in view. It is one object of the present invention to provide an ATCA (Advanced Telecom Computing Architecture) card assembly, which fully utilizes the limited ATCA card surface space for holding multiple hard disk drives.

To achieve this and other objects of the present invention, the ATCA (Advanced Telecom Computing Architecture) card assembly comprises a circuit board, a rear transition module mounted on the circuit board, a plurality of hard disk drives supported on the rear transition module, and an adapter structure that electrically connects the hard disk drives to the rear transmission module. The rear transition module has an electric connecting portion disposed at one side and formed of a plurality of metal contacts. The adapter structure comprises a hard disk drive mounting module, said hard disk drive mounting module comprising a holder frame and an adapter. The holder frame holds the hard disk drives on the rear transition module in a stack and has at least one front mounting lug. The adapter comprises an adapter board affixed to the circuit board and the at least one front mounting lug of the holder frame, and a plurality of electrical connectors respectively perpendicularly extending from the adapter board at different elevations and respectively electrically connected to the electric connecting portion of the rear transition module and the hard disk drives. The hard disk drives are arranged in a stack in the holder frame, each having an electrical connector respectively connected to a respective electrical connector of the adapter.

### BRIEF DESCRIPTION OF THE DRAWINGS

FIG. 1 is an elevational assembly view of the preferred embodiment of the present invention.

FIG. 2 is an exploded view of the preferred embodiment of the present invention.

FIG. 3 is an oblique elevation in an enlarged scale of the adapter shown in FIG. 2.

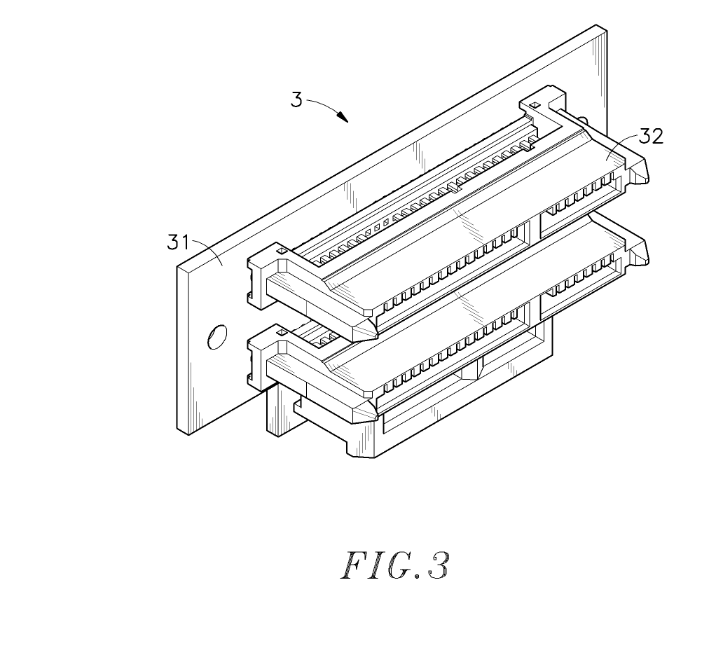

FIG. 4 is sectional view in an enlarged scale of a part of FIG. 1.

FIG. 5 is an exploded view of blade server chassis according to the prior art.

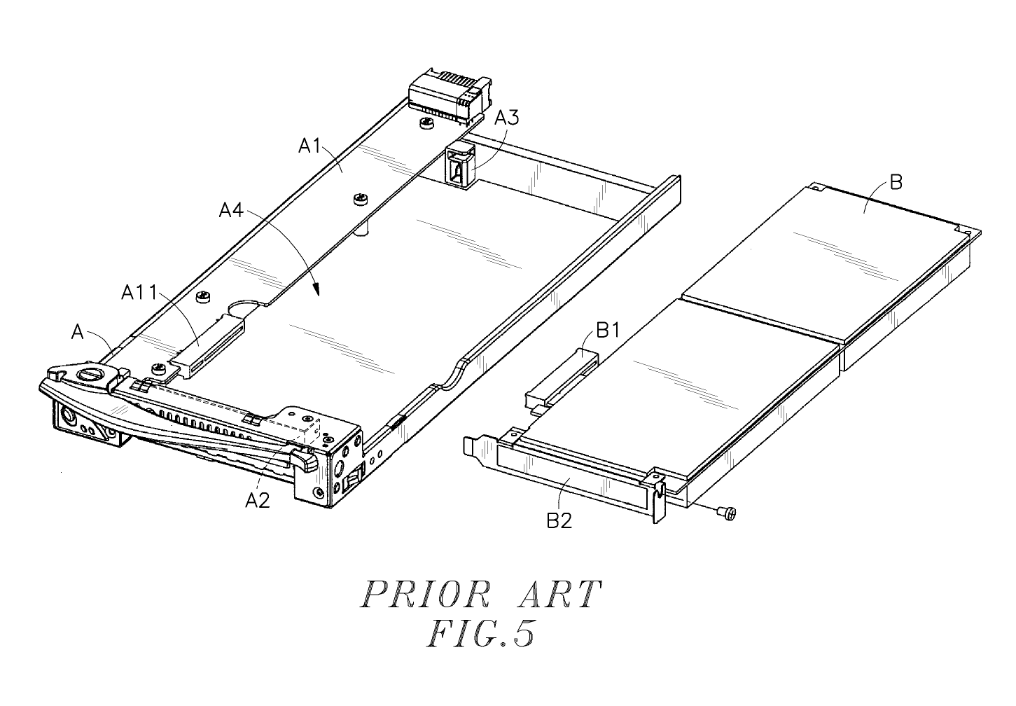

### DETAILED DESCRIPTION OF THE PREFERRED EMBODIMENT

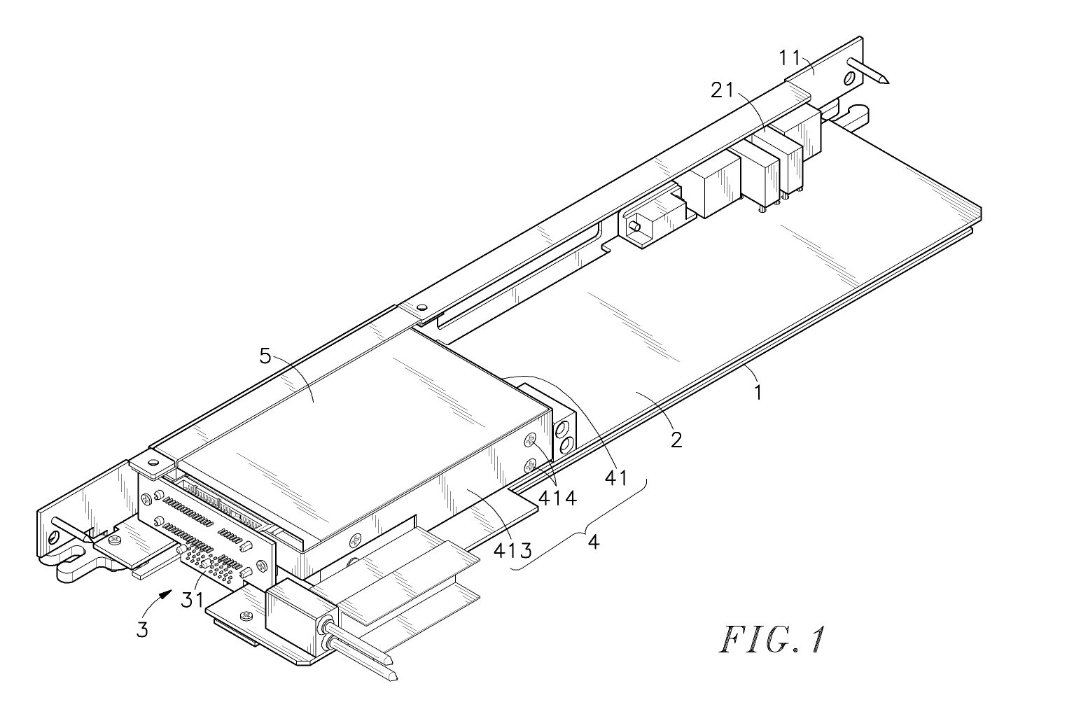

Referring to FIGS. 1˜3, an ATCA (Advanced Telecom Computing Architecture) card assembly in accordance with the present invention is shown comprising a circuit board 1, a RTM (Rear Transition Module) 2, an adapter 3, and a hard disk drive mounting module 4.

The circuit board 1 has a face panel 11 at one side.

The RTM 2 is equipped with many electronic parts and an electrical connector 21, having an electric connecting portion 22 formed of metal contacts (gold fingers) and disposed at one side.

The adapter 3 comprises an adapter board 31 and a plurality of electrical connectors 32 arranged on one side of the adapter board 31 at different elevations.

The hard disk drive mounting module 4 comprises a holder frame 41. The holder frame 41 has two side panels 413 arranged in parallel at two sides and defining an accommodation open space 411, at least one, for example, and two front mounting lugs 412 respectively extending from the side panels 413 at right angles and facing each. The front mounting lugs 412 each have a mounting through hole 4121. The side panels 413 each have a plurality of mounting screw holes 4131.

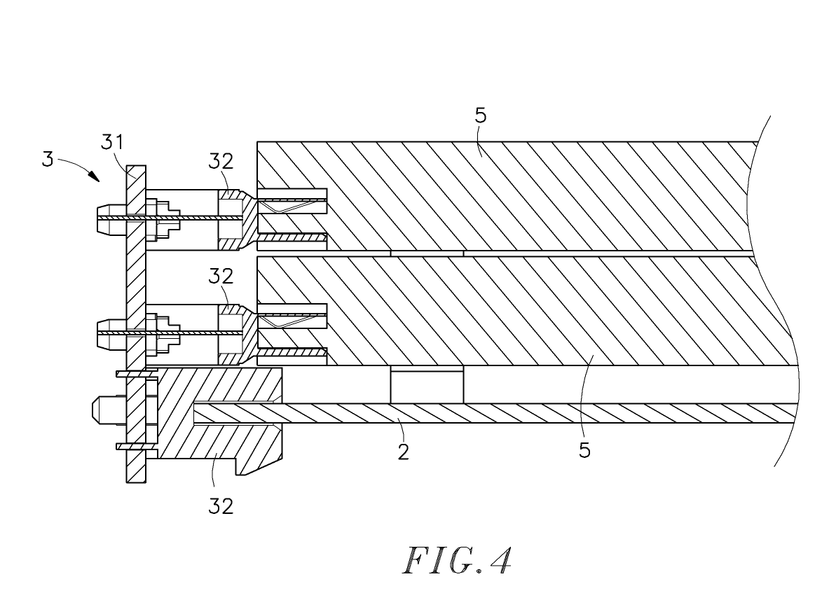

Referring to FIG. 4 and FIGS. 1˜3 again, during installation of the present invention, the RTM 2 is fixedly mounted on the circuit board 1 to have the electrical connector 21 be connected to electrical connector means (not shown) at the face panel 11, and then the holder frame 41 of the hard disk drive mounting module 4 is attached to the RTM 2, and then hard disk drives 5 are mounted in a stack in the accommodation open space 411 within the holder frame 41 above the RTM 2, and then screws 414 are respectively fastened to the mounting screw holes 4131 of the side panels 413 of the holder frame 41 and respective mounting screw holes 51 of the hard disk drives 5 to affix the hard disk drives 5 to the holder frame 41, and then the electrical connectors 32 of the adapter 3 are respectively connected to the electric connecting portion 22 of the RTM 2 and respective electrical connectors 52 of the hard disk drives 5 are respectively connected to the electrical connectors 32 of the adapter 3 is affixed to the circuit board 1, and finally, screws 414 are respectively fastened to the mounting through hole 4121 of the front mounting lugs 412 and the adapter board 31 of the adapter 3 to affix the adapter board 31 of the adapter 3 to the holder frame 41 of the hard disk drive mounting module 4. By means of the adapter 3 and the RTM 2, the hard disk drives 5 are electrically connected to the ATCA card for data access.

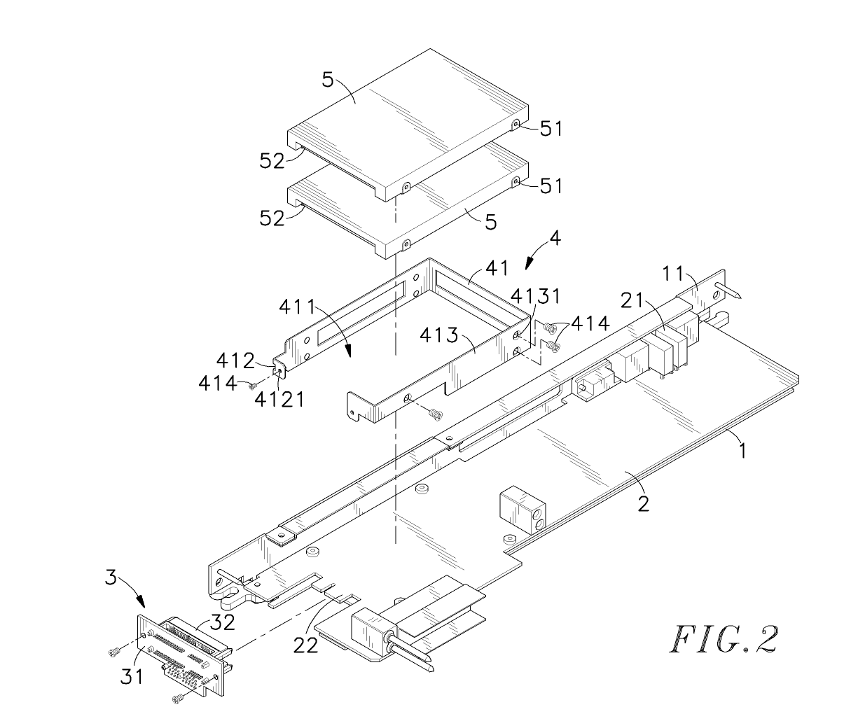

Referring to FIGS. 2˜4 again, the hard disk drives 5 are arranged in a stack and electrically connected to the respective electrical connectors 32 at the adapter board 31 at different elevations. The electrical connectors 32 of the adapter board 3 can be made subject to SATA (Serial Advanced Technology Attachment), SAS (Serial Attachment SCSI), FC (Fiber Channel), or USB (Universal Serial Bus) to fit the electrical connectors 52 of the hard disk drives 5. By means of the electrical connectors 32 of the adapter board 3, the hard disk drives 5 are electrically connected to the electric connecting portion 22 of the RTM 2 for signal transmission and data access.

Further, by means of the hard disk drive mounting module 4, the hard disk drives 5 are mounted on the circuit board 1 in a stack. Therefore, the installation of the hard disk drives 5 does not occupy much surface space of the circuit board 1, i.e., the installation of the hard disk drives 5 does not interfere with the circuit layout of the circuit board 1.

As stated above, the invention provides a multilayer hard disk mounting arrangement of an ATCA card in which hard disk drives 5 are arranged in a stack inside the holder frame 41 of the hard disk drive mounting module 4 at the RTM 2 above the circuit board 1 of the ATCA card and affixed to the side panels 413 of the holder frame 41 with the screws 414, and the adapter board 3 is fastened to the RTM 2 at one side to electrically connect the hard disk drives 5 to the RTM 2. This mounting arrangement has benefits as follows:

1. The hard disk drives 5 are arranged in a stack inside the holder frame 41 of the hard disk drive mounting module 4 at the RTM 2 above the circuit board 1 of the ATCA card, therefore, the installation of the hard disk drives 5 neither occupies much surface space of the circuit board 1 and nor interfere with the circuit layout of the circuit board 1.

2. The hard disk drives 5 are fastened to the mounting screw holes 4131 of the side panels 413 of the holder frame 41 with screws 414. This mounting procedure is easy and saves much installation time and labor.

3. The hard disk drives 5 are arranged in a stack above the circuit board 1. This design allows the user to increase the number of the hard disk drives 5 at the circuit board 1 without occupying much surface space of the circuit board 1.

A prototype of multilayer hard disk mounting arrangement of an ATCA card assembly has been constructed with the features of FIGS. 1˜4. The multilayer hard disk mounting arrangement of an ATCA card assembly functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An ATCA (Advanced Telecom Computing Architecture) card assembly comprising a circuit board, a rear transition module mounted on said circuit board, said rear transition module having an electric connecting portion disposed at one side and formed of a plurality of metal contacts, a plurality of hard disk drives supported on said rear transition module, and an adapter structure that electrically connects said hard disk drives to said rear transmission module, wherein said adapter structure comprises a hard disk drive mounting module, said hard disk drive mounting module comprising a holder frame and an adapter, said holder frame holding said hard disk drives on said rear transition module in a stack, said holder frame having at least one front mounting lug, said adapter comprising an adapter board affixed to said circuit board and said at least one mounting lug of said holder frame and a plurality of electrical connectors respectively perpendicularly extending from said adapter board at different elevations and respectively electrically connected to said electric connecting portion of said rear transition module and said hard disk drives; said hard disk drives are arranged in a stack in said holder frame, each having an electrical connector respectively connected to a respective electrical connector of said adapter.

2. The ATCA (Advanced Telecom Computing Architecture) card assembly as claimed in claim 1, wherein said circuit board has a face panel at one side thereof, said face panel having electric connector means electrically connected to said rear transition module.

3. The ATCA (Advanced Telecom Computing Architecture) card assembly as claimed in claim 1, wherein said holder frame of said hard disk drive mounting module defines an accommodation open space that accommodates said hard disk drives in a stack.

4. The ATCA (Advanced Telecom Computing Architecture) card assembly as claimed in claim 1, wherein the electrical connectors of said adapter are made subject to one of the technologies of SATA (Serial Advanced Technology Attachment), SAS (Serial Attachment SCSI), FC (Fiber Channel), and USB (Universal Serial Bus).
